(19) United States
(12) Patent Application Publication
(10) Pub. No.: US 2025/0388819 A1
(43) Pub. Date: Dec. 25, 2025

(54) CATALYST AND PROCESS TO MAKE RENEWABLE DIESEL AND SUSTAINABLE AVIATION FUEL

(71) Applicant: CHEVRON U.S.A. INC., San Ramon, CA (US)

(72) Inventors: Horacio TREVINO, Richmond, CA (US); Himal MUNSIF, hOUSTON, TX (US); Michelle YOUNG, Manvel, TX (US); Cameron A. MCCORD, Eugene, OR (US)

(21) Appl. No.: 18/880,257

(22) PCT Filed: Jun. 15, 2023
(86) PCT No.: PCT/IB2023/056186

§ 371 Date: Dec. 30, 2024

Related U.S. Application Data
(60) Provisional application No. 63/357,626, filed on Jun. 30, 2022.

(51) Int. Cl. C10G 3/00; B01J 29/70; B01J 35/50

(52) U.S. Cl. CPC C10G 3/44; B01J 29/7023; B01J 29/703; B01J 35/50; C10G 3/50; B01J 2235/15; C10G 2300/1014; C10G 2300/1018; C10G 2300/70; C10G 2400/04

(57) ABSTRACT

A process for making a renewable product from a biofeedstock, in which a biofeedstock is contacted with a hydroconversion catalyst under hydroconversion conditions, the biofeedstock comprising one or more biocomponents, and the hydroconversion catalyst comprising a hydrotreating catalyst and a hydroisomerization catalyst.

### CROSS REFERENCE TO RELATED APPLICATIONS

This application is related to and claims the benefit of priority to U.S. Provisional Patent Appl. Ser. No. 63/357,626 filed on 30 Jun. 2022, entitled “CATALYST AND PROCESS TO MAKE RENEWABLE DIESEL AND SUSTAINABLE AVIATION FUEL”, the disclosure of which is herein incorporated in its entirety.

### FIELD OF THE INVENTION

Described herein are processes for hydroconversion of biofeedstocks and biocomponents feeds to produce renewable products, such as renewable diesel and/or sustainable aviation fuel.

### BACKGROUND

The use of renewable resources has garnered significant attention and effort in the drive to develop fossil fuel alternatives. The variety, availability and versatility of various biofeedstocks has been of great interest, particularly certain lipid sources and other carbohydrates, leading to the development and commercial use of a number of bio-based fuel technologies. Ongoing economic interests, and the desire to reduce fossil fuel use, have provided incentives for improvements in existing technologies, and the development of new processes for utilizing renewable biofeedstocks to produce renewable fuels and other renewable products.

Renewable fuels (biofuels) are seen as being important to reduce carbon and greenhouse emissions. Biofuels derived from food are fuels typically made from food sources produced on arable land, while biofuels derived from non-food sources are typically produced from lignocellulosic biomass like forestry residuals or agricultural residues/waste. Typical biofeedstocks in the food source category include a wide variety of lipids (e.g., vegetable oil, including used cooking oil, seed oils, animal fats, waste oils, algae oils, and the like). Typical non-food source feedstocks include wood, grasses, algae, crop byproduct, municipal solid waste, and the like. While renewable fuels derived from non-food sources are sometimes preferred over biofuels derived from food sources, there remains an ongoing need for improvements in hydroconversion processes for all feedstock sources to produce renewable products, such as sustainable aviation fuel and/or renewable diesel.

### SUMMARY OF THE INVENTION

This invention relates to processes for making renewable products from biofeedstocks, e.g., feeds containing biocomponents of biological origin. Sustainable aviation fuel and renewable diesel may be produced or components thereof.

In one aspect, a process for making sustainable jet fuel is provided, the process comprising contacting a hydrocarbonaceous feedstock with a hydroconversion catalyst, wherein the feedstock comprises or is a biofeedstock or a biocomponent feed, and the hydroconversion catalyst comprises zeolite SSZ-91

In another aspect, a process for flexibly making sustainable jet fuel and/or renewable diesel from the same hydrocarbonaceous feedstock is provided, the process comprising contacting a hydrocarbonaceous feedstock with a hydroconversion catalyst, wherein the feedstock comprises or is biofeedstock or a biocomponent feed, and the hydroconversion catalyst comprises zeolite SSZ-91.

In another aspect, a process for upgrading a hydrocarbonaceous feedstock is provided, the process comprising contacting a hydrocarbonaceous feedstock with a hydroconversion catalyst under hydroconversion conditions to provide a diesel fuel that is both hydrotreated and hydroisomerized and having a reduced cloud point and/or a reduced pour point compared to the cloud point and pour point of the hydrotreated hydrocarbonaceous feedstock that has not been hydroisomerized, and/or to provide a jet fuel that is both hydrotreated and hydroisomerized and having a boiling point range and/or a reduced jet fuel freezing point compared to the jet fuel boiling point range and/or the jet fuel freezing point of the hydrotreated hydrocarbonaceous feedstock that has not been hydroisomerized; wherein the hydrocarbonaceous feedstock comprises or is a biofeedstock or a biocomponent feed, and the hydroconversion catalyst comprises zeolite SSZ-91.

In another aspect, a process for providing a diesel fuel exhibiting a lower cloud point and a lower pour point compared to the cloud point and pour point of a hydrotreated feedstock from which the diesel fuel is produced is provided, the process comprising contacting a diesel feedstock and a hydroconversion catalyst comprising zeolite SSZ 91 under hydroconversion conditions to provide a diesel fuel exhibiting a lower cloud point and a lower pour point compared to the cloud point and pour point of a hydrotreated feedstock from which the diesel fuel is produced, wherein the feedstock comprises or is a biofeedstock or a biocomponent feed.

In another aspect, a process for providing a jet fuel exhibiting a reduced jet fuel freezing point and/or an improved jet fuel boiling point range compared to the jet fuel freezing point and/or the jet fuel boiling point range of a hydrotreated feedstock from which the jet fuel is produced is provided, the process comprising contacting a jet fuel feedstock and a hydroconversion catalyst comprising zeolite SSZ-91 under hydroconversion conditions to provide a jet fuel exhibiting a reduced jet fuel freezing point and/or an improved jet fuel boiling point range compared to the jet fuel freezing point and/or the jet fuel boiling point range of a hydrotreated feedstock from which the jet fuel is produced, wherein the feedstock comprises or is a biofeedstock or a biocomponent feed.

The skilled person will appreciate that, except where mutually exclusive, a feature described in relation to any aspect or embodiment described herein may be applied mutatis mutandis to any other aspect and/or embodiment. Furthermore, except where mutually exclusive, any feature described herein may be applied to any aspect/embodiment and/or combined with any other feature described herein.

### DETAILED DESCRIPTION

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments is able to learn and understand the different described aspects of the invention. The description of embodiments should facilitate understanding of the invention such that other implementations, not specifically covered but within the ability of a person of skill in the art having read the description of embodiments, to be understood as being consistent with an application of the invention.

Unless otherwise indicated, the following terms have the meanings as defined hereinbelow.

The term “hydroconversion” refers to processes or steps performed in the presence of hydrogen for the hydrocracking, hydrogenation, hydrodeoxygenation, hydrodesulfurization, hydrodenitrogenation, hydrodemetallation, hydrodechlorination, hydrodecarboxylation, hydrodecarbonylation and/or hydrodearomatization (e.g., impurities) of a hydrocarbon or biomass feedstock, and/or for the hydrogenation of unsaturated compounds in the feedstock. Depending on the type of hydrocracking and the reaction conditions, products of hydrocracking processes may have improved aromatic content, oxygen content, viscosities, viscosity indices, saturates content, low temperature properties, volatilities, and depolarization, for example.

The term “hydrotreating” refers to processes or steps performed in the presence of hydrogen for the hydrodesulfurization, hydrodenitrogenation, hydrodeoxygenation, hydrodemetallation, and/or hydrodearomatization of components (e.g., impurities) of a feedstock, and/or for the hydrogenation of unsaturated compounds in the feedstock.

The term “biofeedstock” as used herein refers to biocomponent feeds that are from or are derived a biological source. Exemplary biofeedstocks include lipids, pyrolysis oils, biomass derived feeds, and the like. Triglycerides are a component of some biofeedstocks, such as lipids. The biofeedstock typically has a boiling range suitable for producing a diesel, aviation or other fuel, or distillate therefrom. In the case of some biofeedstocks comprising triglycerides, such feedstocks have an “apparent” boiling temperature range (based on the GC elution time of the triglyceride peaks according to Simdist method ASTM D-2887) suitable for producing a diesel, aviation or other fuel, or distillate therefrom. The biofeedstock boiling range (or apparent boiling range) may also be suitable for producing a base oil or a component thereof. In some embodiments, the biofeedstock has a boiling point range of about 250° F. (121° C.) to about 900° F. (482° C.), for example about 300° F. (149° C.) to about 900° F. (482° C.), or about 250° F. (121° C.) to about 800° F. (427° C.). In some cases, e.g., for typical lipids after hydrotreating, an upper boiling point of about 900° F. (482° C.) includes hydrocarbon molecules having a number of carbon atoms that makes them suitable for the applications described herein.

The term “biocomponent feed” used herein is used to refer to a feedstock derived from a biocomponent-containing source, such as a plant based oil or fat, an animal based oil or fat, a fish based oil or fat or algae based oil or fat. In some embodiments, the biocomponent feed has a boiling point range of about 250° F. (121° C.) to about 900° F. (482° C.), for example about 300° F. (149° C.) to about 900° F. (482° C.), about 400° F. to about 900° F. (about 204° C. to about 482° C.), about 500° F. to about 900° F. (about 260° C. to about 482° C.), about 600° F. (316° C.) to about 900° F. (482° C.), or about 700° F. (371° C.) to about 900° F. (482° C.) at atmospheric pressure. In some embodiments, the biocomponent feed has a 90% distillation temperature of less than about 1000° F. (538° C.), or 900° F. (482° C.), or 800° F. (427° C.) or 700° F. (371° C.), or less than about 650° F. (343° C.). In some embodiments, the biocomponent feed has a 90% distillation temperature in the range of about 550° F. (288° C.) to about 750° F. (399° C.), for example about 550° F. (288° C.) to about 700° F. (371° C.), about 600° F. (316° C.) to about 700° F. (371° C.). The 90% distillation temperature may be determined in accordance with ASTM D-2887. In some embodiments, the biocomponent feed has a 5% distillation temperature in the range of about 250° F. (121° C.) to about 600° F. (316° C.), for example about 300° F. (149° C.) to about 600° F. (316° C.), or about 400° F. (about 204° C.) to about 600° F. (316° C.). The 5% distillation temperature may be determined in accordance with ASTM D 2887. In some embodiments, the biocomponent feed has a 90% distillation temperature in the range of about 550° F. (about 288° C.) to about 750° F. (about 399° C.) and a 5% distillation temperature in the range of about 250° F. (121° C.) to about 600° F. (316° C.). In some embodiments, the biocomponent feed has a 90% distillation temperature in the range of about 550° F. (288° C.) to about 700° F. (371° C.) and a 5% distillation temperature in the range of about 300° F. (149° C.) to about 600° F. (316° C.). In some embodiments, the biocomponent feed has a 90% distillation temperature which is greater than about 600° F. (316° C.), for example from about 605° F. (about 318° C.) to about 675° F. (357° C.), and a 5% distillation temperature which is less than about 600° F. (316° C.), for example from about 540° F. (282° C.) to about 580° F. (304° C.). In some embodiments, the biocomponent feed has a 90% distillation temperature in the range of equal to or greater than about 600° F. (316° C.) to about 700° F. (371° C.) and a 5% distillation temperature in the range of about 400° F. (204° C.) to equal to or less than about 600° F. (316° C.). In some cases, e.g., for typical lipids after hydrotreating, an upper boiling point of about 900° F. (482° C.) includes hydrocarbon molecules having a number of carbon atoms that makes them suitable for the applications described herein.

The term “diesel fuel” is used herein to refer to a hydrocarbon product having boiling points in the range of about 300° F. to about 800° F. (about 149° C. to about 427° C.) at atmospheric pressure.

The term “active source” means a reagent or precursor material capable of supplying at least one element in a form that can react and which can be incorporated into the molecular sieve structure. The terms “source” and “active source” can be used interchangeably herein.

The term “molecular sieve” and “zeolite” are synonymous and include (a) intermediate and (b) final or target molecular sieves and molecular sieves produced by (1) direct synthesis or (2) post-crystallization treatment (secondary modification). Secondary synthesis techniques allow for the synthesis of a target material from an intermediate material by heteroatom lattice substitution or other techniques. For example, an aluminosilicate can be synthesized from an intermediate borosilicate by post-crystallization heteroatom lattice substitution of the Al for B. Such techniques are known, for example as described in U.S. Pat. No. 6,790,433 to C. Y. Chen and Stacey Zones, issued Sep. 14, 2004.

The terms “*MRE-type molecular sieve”, “EUO-type molecular sieve” and “MTT-type molecular sieve” includes all molecular sieves and their isotypes that have been assigned the International Zeolite Association framework, as described in the Atlas of Zeolite Framework Types, eds. Ch. Baerlocher, L. B. McCusker and D. H. Olson, Elsevier, 6^{th} revised edition, 2007 and the Database of Zeolite Structures on the International Zeolite Association's website (http://www.iza-online.org).

SiO₂/Al₂O₃ Ratio (SAR): determined by ICP elemental analysis. A SAR of infinity (∞) represents the case where there is no aluminum in the zeolite, i.e., the mole ratio of silica to alumina is infinity. In that case, the molecular sieve is comprised essentially of silica.

As used herein, the term “pour point” refers to the temperature at which an oil will begin to flow under controlled conditions. The pour point may be determined by ASTM D5950.

As used herein, “cloud point” refers to the temperature at which a sample begins to develop a haze as the oil is cooled under specified conditions. Cloud point may be determined by ASTM D5773.

“Group 2, 8, 9 and 10 metals” refers to elemental metal(s) selected from Groups 2, 8, 9 and 10 of the Periodic Table of the Elements and/or to metal compounds comprising such metal(s). “Group 6 metals” refers to elemental metal(s) selected from Group 6 of the Periodic Table of the Elements and/or to metal compounds comprising such metal(s).

The term “Periodic Table” refers to the version of IUPAC Periodic Table of the Elements dated 1 Dec. 2018.

Unless otherwise specified, the “feed rate” of a feedstock being fed to a catalytic reaction zone is expressed herein as the volume of feed per volume of catalyst per hour, which may be referred to as liquid hourly space velocity (LHSV) with units of reciprocal hours (h⁻¹).

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

Unless otherwise specified, the recitation of a genus of elements, materials, or other components, from which an individual component or mixture of components can be selected, is intended to include all possible sub-generic combinations of the listed components and mixtures thereof. In addition, all number ranges presented herein are inclusive of their upper and lower limit values.

If a standard test is mentioned herein, unless otherwise stated, the version of the test to be referred to is the most recent at the time of filing this patent application.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

Biofeedstocks described herein comprise or are a biocomponent feed. In some embodiments, the biofeedstock comprises, consists essentially of, or consists of a biocomponent feed. In some embodiments, the biocomponent feed constitutes at least about 5 wt. % of the biofeedstock, for example, at least about 10 wt. %, at least about 20 wt. %, at least about 30 wt. %, at least about 40 wt. %, at least about 50 wt. %, at least about 60 wt. %, at least about 70 wt. %, at least about 80 wt. %, at least about 90 wt. %, at least about 95 wt. %, at least about 98 wt. %, or at least about 99 wt. % of the biofeedstock. In some embodiments, the biocomponent feed constitutes 5 wt. % to 100 wt. % of the biofeedstock, for example 10 wt. % to 100 wt. %, 50 wt. % to 100 wt. %, 80 wt. % to 100 wt. %, 95 wt. % to 100 wt. % of the biofeedstock.

In some embodiments, the biofeedstock comprises, consists essentially of or consists of a biocomponent feed. In some embodiments, the biocomponent feed constitutes at least about 5 wt. % of the biofeedstock, for example, at least about 10 wt. %, at least about 20 wt. %, at least about 30 wt. %, at least about 40 wt. %, at least about 50 wt. %, at least about 60 wt. %, at least about 70 wt. %, at least about 80 wt. %, at least about 90 wt. %, at least about 95 wt. %, at least about 98 wt. %, or at least about 99 wt. % of the biofeedstock. In some embodiments, the biocomponent feed constitutes 5 wt. % to 100 wt. % of the biofeedstock, for example 10 wt. % to 100 wt. %, 50 wt. % to 100 wt. %, 80 wt. % to 100 wt. %, 95 wt. % to 100 wt. % of the biofeedstock.

In some embodiments, the biofeedstock is a blended feedstock comprising a biocomponent feed, or also comprising a hydrocarbon (e.g., petroleum) feed, in combination with another feedstock such as a blend feed. For example, the blended feedstock may comprise a blend feed selected from gas oils, vacuum gas oils, long residues, vacuum residues, atmospheric distillates, heavy fuels, oils, waxes and paraffins, used oils, deasphalted residues or crudes, charges resulting from thermal or catalytic conversion processes, or a combination thereof. In some embodiments, the blend feed is selected from whole crude petroleum, reduced crudes, vacuum tower residua, cycle oils, synthetic crudes, gas oils, vacuum gas oils, foots oils, Fischer-Tropsch derived waxes, lubricating oil stocks, heating oils, heavy neutral feeds, hydrotreated gas oils, hydrocracked gas oils, hydrotreated lubricating oil raffinates, brightstocks, lubricating oil stocks, synthetic oils, high pour point polyolefins (for example, polyolefins having a pour point of about 0° C. or above); normal alpha olefin waxes, slack waxes, deoiled waxes, microcrystalline waxes, residuum fractions from atmospheric pressure distillation processes, solvent-deasphalted petroleum residua, shale oils, cycle oils, petroleum wax, slack wax, and waxes produced in chemical plant processes. In some embodiments, the feedstock is a blended feedstock comprising a biocomponent feed and a non-biocomponent hydrocarbon feed. In some embodiments, the feedstock is a blended feedstock comprising a biocomponent feed, a hydrocarbon feed and a blend feed (for example, a blend feed, supra). The blended feedstock, blend feed, and/or biofeedstock may also comprise a recycled product and/or intermediate process stream.

In some embodiments, the feedstock is a blended feedstock comprising a biocomponent feed and a blend feed, where the blended feedstock comprises at least about 5 wt. % of the biocomponent feed and up to about 95 wt. % of a blend feed, for example, at least about 10 wt. % of the biocomponent feed and up to about 90 wt. % of a blend feed, at least about 50 wt. % of the biocomponent feed and up to about 50 wt. % of a blend feed, at least about 80 wt. % of the biocomponent feed and up to about 20 wt. % of a blend feed, or at least about 95 wt. % of the biocomponent feed and up to about 5 wt. % of a blend feed.

A Fischer-Tropsch feed (if used) will typically have a paraffin content of at least about 90 wt. %, for example, at least about 95 wt. %, or at least about 97.5 wt. %. The Fischer-Tropsch feed typically comprises only very minor amounts of olefins and cycloparaffins, for example, less than about 1.0 wt. % olefin, or less than about 0.5 wt. % olefin, and/or less than about 1.0 wt. % cycloparaffin, less than about 0.5 wt. % cycloparaffin, or less than about 0.1 wt. % cycloparaffin. In some embodiments, the Fischer-Tropsch feed has a S content of less than about 50 ppm, for example less than about 20 ppm. In some embodiments, the Fischer-Tropsch feed has a N content of less than about 50 ppm, for example less than about 20 ppm. In some embodiments, the Fischer-Tropsch feed has a metal content of less than about 10 ppm, for example less than about 5 ppm. The paraffin content and cylcoparaffin content of the Fischer-Tropsch feed may be determined by GC-FIMS analysis as described in “Diesel Fuel Analysis by GC-FIMS: Normal Paraffins, Isoparaffins and Cycloparaffins”, Briker, Y., et al., Energy Fuels 2001, 15, 4, 996-1002. The nitrogen content of the Fischer-Tropsch feed may be determined in accordance with ASTM D3228-20. The sulfur content of the Fischer-Tropsch feed may be determined in accordance with ASTM D4629. The metal content of the Fischer-Tropsch feed may be measured by inductively coupled plasma atomic emission spectroscopy (ICPAES).

In some embodiments, the feedstock may comprise a blended feedstock comprising a Fischer-Tropsch feed in combination with a blend feed, where the blended feedstock comprises at least about 5 wt. % of the Fischer-Tropsch feed and up to about 95 wt. % of a blend feed, for example at least about 10 wt. % of the Fischer-Tropsch feed and up to about 90 wt. % of a blend feed, at least about 50 wt. % of the Fischer-Tropsch feed and up to about 50 wt. % of a blend feed, at least about 80 wt. % of the Fischer-Tropsch feed and up to about 20 wt. % of a blend feed, or at least about 95 wt. % of the Fischer-Tropsch feed and up to about 5 wt. % of a blend feed.

In some embodiments, the biofeedstock comprises, consists essentially of or consists of a biocomponent feed. Plant-based oils and fats include vegetable oils and fats, such as rapeseed (canola) oil, soybean oil, coconut oil, sunflower oil, palm oil, palm kernel oil, peanut oil, linseed oil, colza oil, tall oil, corn oil, castor oil, jatropha oil, jojoba oil, olive oil, flaxseed oil, hempseed oil, cottonseed oil, camelina oil, safflower oil, mustard oil, cuphea oil, curcas oil, crambe oil, babassu oil, tallow oil, and rice bran oil. Animal oils and fats, and other sources, include beef fat (tallow), hog fat (lard), turkey fat, fish fat/oil, and chicken fat), yellow and brown greases, including algae and fish fats/oils, fats in milk, sewage sludge, and the like.

In some embodiments, the biocomponent feed is selected from vegetable oils and animal fats comprising, or consisting essentially of, triglycerides and free fatty acids (FFA). In some embodiments, the biofeedstock comprises or is a biocomponent feed selected from lipids, vegetable oils and animal fats which comprise triglycerides and free fatty acids, for example wherein the biocomponent feed is selected from canola oil, corn oil, soy oils, castor oil, camelina oil, palm oil and a combination thereof.

In some embodiments, the triglycerides and FFAs contain aliphatic hydrocarbon chains in their structure having 6-24 carbon atoms (for example, 8 to 24, 8 to 20, or 10-16 carbon atoms). In some embodiments, the biocomponent feed comprises triglycerides having the general formula (1):

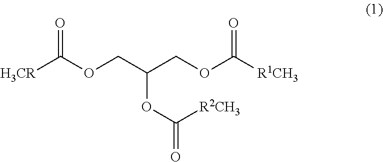

where R, R¹ and R² are independently aliphatic hydrocarbon chains having from 6-24 carbon atoms (for example, 8 to 24, 8 to 20, 10-20, 10-18, or 10-16 carbon atoms). In some embodiments, R, R¹ and R² are independently branched or un-branched, substituted or unsubstituted, completely saturated or contain one or more (for example 1-4, 1-3 or 1 or 2) unsaturated carbon-carbon bonds. In some embodiments, R, R¹ and R² are unsubstituted. In some embodiments, R, R¹ and R² are independently completely saturated or contain one or more (for example 1-4, 1-3 or 1 or 2) unsaturated carbon-carbon bonds. In some embodiments, R, R¹ and R² are un-branched.

In some embodiments, the biocomponent feed comprises free fatty acids (FFAs) having aliphatic hydrocarbon tails of 6 to 24 carbon atoms, for example 8 to 24 carbon atoms, 8 to 20 carbon atoms, 10 to 20 carbon atoms, 10 to 18 carbon atoms, or 10-16 carbon atoms. In some embodiments, the FFAs comprise unsaturated or saturated aliphatic hydrocarbon tails. In some embodiments, the FFAs comprise unbranched or branched aliphatic hydrocarbon tails.

In some embodiments, the biocomponent feed is selected from canola oil, corn oil, soy oils, castor oil, camelina oil, palm oil and combinations thereof.

In some embodiments, the biocomponent feed has an oxygenate content of at least about 0.5 wt. % by total weight of the biocomponent feed, for example, at least about 1.0 wt. %, at least about 2.0 wt. %, at least about 3.0 wt. %, at least about 4.0 wt. %, or at least about 5.0 wt. % by total weight of the biocomponent feed. In some embodiments, the biocomponent feed has an oxygenate content of up to about 15 wt. % by total weight of the biocomponent feed, for example up to about 10 wt. % by total weight of the biocomponent feed, or up to about 5 wt. % by total weight of the biocomponent feed. In some embodiments, the biocomponent feed has an oxygenate content in the range of about 1-15 wt. % by total weight of the biocomponent feed, for example, in the range of about 5-15 wt. %, or about 10-15 wt. %, by total weight of the biocomponent feed. The oxygenate content of the biocomponent feed may be measured by neutron activation analysis, for example, in accordance with ASTM E385-90 (2002).

In some embodiments, the biocomponent feed is hydrotreated prior to being contacted a hydroconversion catalyst for further hydroprocessing, e.g., with the hydroisomerization/hydrodewaxing catalyst. In some embodiments, the biocomponent feed has a sulfur(S) content of less than about 200 ppm, for example less than about 100 ppm, less than about 50 ppm or less than about 20 ppm. In some embodiments, the biocomponent feed has a nitrogen (N) content of less than about 50 ppm, for example less than about 20 ppm, or less than about 10 ppm. In some embodiments, the hydrotreated biocomponent feed has an oxygenate content that is typically about 0 wt. %, or, alternatively, of less than about 2 wt. %, or 5 wt. %. The nitrogen content of the biocomponent feed may be determined in accordance with ASTM D4629. The sulfur content of the biocomponent feed may be determined in accordance with ASTM D2622.

The hydroconversion catalyst may comprise a hydrotreating catalyst and/or a hydroisomerization catalyst and may include a precious metal catalyst as the hydroconversion catalyst. In other cases, the hydroconversion catalyst may include a base metal catalyst and a precious metal catalyst. While not limited thereto, the base metal catalyst typically includes a base metal selected from Mo, Ni, W, Co, and combinations thereof, or Mo, or a combination of Mo and Ni. Similarly, while not limited thereto, the precious metal catalyst typically includes a precious metal selected from Pt, Pd, or a combination thereof.

The term “hydroisomerization catalyst” as used herein refers to a catalyst that facilitates the skeletal isomerization of hydrocarbon molecules. In some embodiments, suitable hydroisomerization catalysts include catalysts comprising zeolite SSZ-91. Other hydroisomerization catalysts may also be suitable, including, e.g., catalysts based on zeolite SSZ-32 and/or zeolite SSZ-32x. Combinations of suitable hydroisomerization catalysts based on the same or different zeolite supports may also be used.

In some embodiments, the hydroisomerization catalyst comprises zeolite SSZ-91, or from about 5 to about 95 wt. % zeolite SSZ-91 by total weight of the hydroisomerization catalyst, or from about 10 to about 95 wt. % zeolite SSZ-91, from about 20 to about 90 wt. % zeolite SSZ-91, or from about 25 to about 85 wt. % zeolite SSZ-91, or from about 30 to about 80 wt. % zeolite SSZ-91, or from about 35 to about 75 wt. % zeolite SSZ-91, or from about 35 to about 65 wt. % zeolite SSZ-91, or from about 35 to about 55 wt. % zeolite SSZ-91, or from about 45 to about 75 wt. % zeolite SSZ-91, or from about 55 to about 75 wt. % zeolite SSZ-91 by total weight of the hydroisomerization catalyst.

The hydroisomerization catalyst further comprises a metal modifier, for example a metal modifier selected from Group 2, 8, 9 and 10 metals or combinations thereof. In some embodiments, the metal modifier is selected from Group 8, 9 or 10 metals and combinations thereof, for example the metal modifier may be selected from Fe, Co, Ni, Ru, Rh, Pd, Os, Ir, Pt and combinations thereof. In some embodiments, the metal modifier is selected from Group 10 metals and combinations thereof. In some embodiments, the hydroisomerization catalyst comprises platinum, palladium, or a combination thereof. Base metals may be included in the catalyst.

In some embodiments, the hydroisomerization catalyst comprises from about 0.05 to about 10 wt. %, or 5 wt. % or 2.0 wt. % of a metal modifier (e.g., selected from Group 2, 8, 9 and 10 metals, or a Group 8, 9 or 10 metal, for example a Group 10 metal such as platinum) by total weight of the hydroisomerization catalyst, for example, about 0.1 to about 1.5 wt. %, or about 0.2 to about 1.5 wt. %, or about 0.1 to about 1 wt. %, by total weight of the hydroisomerization catalyst. In some cases, e.g., where base metals are included, the metal content may be higher, e.g., at least about 5 wt. %, or 10 wt. %, or 15 wt. % or 20 wt. %, or 25 wt. %, or at least about 30 wt. %, or in the range of about 2 wt. % or 5 wt. % to about 25 wt. % or 30 wt. %.

In some embodiments, the hydroisomerization catalyst comprises an oxide binder. In some embodiments, the oxide binder is an inorganic oxide, e.g., the oxide binder may be selected from alumina, silica, ceria, titania, tungsten oxide, zirconia, and combinations thereof. In some embodiments, the hydroisomerization catalyst comprises an oxide binder comprising alumina. Suitable aluminas are commercially available, including, e.g., Catapal® aluminas and Pural® aluminas from Sasol® or Versal® aluminas from UOP®. In general, the alumina can be any alumina known for use as a matrix material in a catalyst base. For example, the alumina can be boehmite, bayerite, γ-alumina, η-alumina, θ-alumina, δ-alumina, χ-alumina, or a mixture thereof. In some embodiments, the hydroisomerization catalyst comprises from about 5 to about 95 wt. % oxide binder by total weight of the hydroisomerization catalyst, for example about 5 to about 80 wt. % oxide binder, about 10 to about 70 wt. % oxide binder a, about 20 to about 70 wt. % oxide binder, for example about 25 to about 65 wt. % oxide binder by total weight of the hydroisomerization catalyst.

In some embodiments, the hydroisomerization catalyst comprises from about 5 to about 95 wt. % zeolite SSZ-91, from about 0.05 to about 2.0 wt. % of a Group 8-10 metal; and from about 5 to about 95 wt. % oxide binder by total weight of the hydroisomerization catalyst. In some embodiments, the hydroisomerization catalyst comprises from about 30 to about 80 wt. % zeolite SSZ-91, from about 0.1 to about 1.5 wt. % of a Group 8-10 metal; and from about 20 to about 70 wt. % oxide binder by total weight of the hydroisomerization catalyst.

Zeolite SSZ-91 and methods for making zeolite SSZ-91 are described in U.S. Pat. No. 9,920,260 which is incorporated herein by reference in its entirety. Zeolite SSZ-91 may also be referred to as SSZ-91 molecular sieve.

Zeolite SSZ-91 has a SiO₂/Al₂O₃ mole ratio (SAR) of 40 to 220. In some embodiments, zeolite SSZ-91 has a SiO₂/Al₂O₃ mole ratio (SAR) of 40 to 220, for example, 70 to 200, 80 to 200, 70 to 180, 80 to 180, 70 to 160, 80 to 160, 70 to 140, 80 to 140, 100 to 160, 100 to 140, or 120 to 140. The SAR is determined by inductively coupled plasma (ICP) elemental analysis.

Zeolite SSZ-91 is composed of at least 70% polytype 6 of the total ZSM-48-type material present in the product. The proportion of polytype 6 of the total ZSM-48-type material present in the product is determined by DIFFaX simulation and as described by Lobo and Koningsveld in J. Am. Chem. Soc. 2012, 124, 13222-13230, where the disorder was tuned by three distinct fault probabilities. It should be noted the phrase “at least X %” includes the case where there are no other ZSM-48 polytypes present in the structure, i.e., the material is 100% polytype 6. The structure of polytype 6 is as described by Lobo and Koningsveld. (See, J. Am. Chem. Soc. 2002, 124, 13222-13230). In some embodiments, the SSZ-91 material is composed of at least 80% polytype 6 of the total ZSM-48-type material present in the product. In some embodiments, the SSZ-91 material is composed of at least 90% polytype 6 of the total ZSM 48-type material present in the product. The polytype 6 structure has been given the framework code *MRE by the Structure Commission of the International Zeolite Association.

Zeolite SSZ-91 has a morphology characterized as polycrystalline aggregates comprising crystallites collectively having an average aspect ratio in the range of 1 to 8. In some embodiments, Zeolite SSZ-91 has a morphology characterized as polycrystalline aggregates comprising crystallites collectively having an average aspect ratio in the range of 1 to 6, for example 1 to 5, 1 to 4 or 1 to 3.

In some embodiments, zeolite SSZ-91 has a morphology characterized as polycrystalline aggregates having a diameter of between about 100 nm and 1.5 μm, each of the aggregates comprising a collection of crystallites collectively having an average aspect ratio in the range of 1 to 8. In some embodiments, zeolite SSZ-91 has a morphology characterized as polycrystalline aggregates having a diameter of between about 100 nm and 1.5 μm, each of the aggregates comprising a collection of crystallites collectively having an average aspect ratio in the range of 1 to 6, for example 1 to 5, 1 to 4 or 1 to 3. As used herein, the term diameter refers to the shortest length on the short end of each crystallite examined.

Zeolite SSZ-91 is a substantially phase pure material. As used herein, the term “substantially phase pure material” means the material is completely free of zeolite phases other than those belonging to the ZSM-48 family of zeolites, or are present in quantities that have less than a measurable effect on, or confer less than a material disadvantage to, the selectivity of the material. Two common phases that co-crystalize with SSZ-91 are EUO-type molecular sieves such as EU-1, as well as Magadiite and Kenyaite. These additional phases may be present as separate phases, or may be intergrown with the SSZ-91 phase.

In some embodiments, zeolite SSZ-91 comprises an EUO-type molecular sieve phase in an amount in the range of 0 to 7 wt. % by weight of the total zeolite SSZ-91 product. In some embodiments, zeolite SSZ-91 comprises an EUO-type molecular sieve phase in an amount in the range of 0 to 5.0 wt. %, for example, 0 to 4.0 wt. %, or 0 to 3.5 wt. %. In some embodiments, zeolite SSZ-91 comprises an EUO-type molecular sieve phase in an amount in the range of 0.1 to 7.0 wt. %, for example, 0.1 to 5.0 wt. %, 0.1 to 4.0 wt. %, or 0.1 to 3.5 wt. %. In some embodiments, zeolite SSZ-91 comprises 0 to 7 wt. % EU-1, for example 0 to 5.0 wt. % EU-1, 0 to 4.0 wt. % EU-1, 0 to 3.5 wt. % EU-1, 0.1 to 7.0 wt. % EU-1, 0.1 to 5.0 wt. % EU-1, 0.1 to 4.0 wt. % EU-1, 0.1 to 3.5 wt. % EU-1, 0.1 to 2 wt. % EU-1, or 0.1 to 1 wt. % EU-1.

It is known that the ratio of powder XRD peak intensities varies linearly as a function of weight fractions for any two phases in a mixture: (Iα/Iβ)=(RIRα/RIRβ)*(xα/xβ), where the RIR (Reference Intensity Ratio) parameters can be found in The International Centre for Diffraction Data's Powder Diffraction File (PDF) database (http://www.icdd.com/products/). The weight percentage of the EUO phase in zeolite SSZ-91 may therefore calculated by measuring the ratio between the peak intensity of the EUO phase and that of the SSZ-91 phase.

In some embodiments, zeolite SSZ-91 comprises a silicon oxide (SiO₂) to aluminum oxide (Al₂O₃) mole ratio (SAR) of 40 to 220; at least 70% polytype 6 of the total ZSM-48-type material; 0 to 7.0 wt. % of an EUO-type molecular sieve phase; wherein the zeolite SSZ-91 has a morphology characterized as polycrystalline aggregates comprising crystallites collectively having an average aspect ratio of between 1 and 8. In some embodiments, zeolite SSZ-91 comprises a silicon oxide (SiO₂) to aluminum oxide (Al₂O₃) mole ratio (SAR) of 40 to 220; at least 70% polytype 6 of the total ZSM-48-type material; 0 to 4.0 wt. % of an EUO-type molecular sieve phase; wherein the zeolite SSZ-91 has a morphology characterized as polycrystalline aggregates comprising crystallites collectively having an average aspect ratio of between 1 and 8. In some embodiments, zeolite SSZ-91 comprises a silicon oxide (SiO₂) to aluminum oxide (Al₂O₃) mole ratio (SAR) of 40 to 220; at least 70% polytype 6 of the total ZSM-48-type material; 0 to 3.5 wt. % of an EUO-type molecular sieve phase; wherein the zeolite SSZ-91 has a morphology characterized as polycrystalline aggregates comprising crystallites collectively having an average aspect ratio of between 1 and 8. Some In some embodiments, zeolite SSZ-91 comprises a silicon oxide (SiO₂) to aluminum oxide (Al₂O₃) mole ratio (SAR) of 40 to 200; at least 70% polytype 6 of the total ZSM-48-type material; 0 to 4.0 wt. % of an EUO-type molecular sieve phase; wherein the zeolite SSZ-91 has a morphology characterized as polycrystalline aggregates comprising crystallites collectively having an average aspect ratio of between 1 and 8. In some embodiments, zeolite SSZ-91 comprises a silicon oxide (SiO₂) to aluminum oxide (Al₂O₃) mole ratio (SAR) of 70 to 200; at least 70% polytype 6 of the total ZSM-48-type material; 0 to 4.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 80 to 200; at least 70% polytype 6 of the total ZSM-48-type material; 0.1 to 7.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 80 to 200; at least 70% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 80 to 200; at least 70% polytype 6 of the total ZSM-48-type material; 0.1 to 4.0 wt. % EU-1; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 80 to 200; at least 70% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 80 to 160; at least 70% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 70 to 160; at least 70% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 70 to 200; at least 80% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 80 to 200; at least 80% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 6. In some embodiments, zeolite SSZ-91 comprises a silicon oxide (SiO₂) to aluminum oxide (Al₂O₃) mole ratio (SAR) of 80 to 200; at least 80% polytype 6 of the total ZSM-48-type material; 0.1 to 7.0 wt. % of an EUO-type molecular sieve phase; wherein the zeolite SSZ-91 has a morphology characterized as polycrystalline aggregates comprising crystallites collectively having an average aspect ratio of between 1 and 4. In some embodiments, zeolite SSZ-91 comprises a silicon oxide (SiO₂) to aluminum oxide (Al₂O₃) mole ratio (SAR) of 80 to 200; at least 80% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 4. In some embodiments, zeolite SSZ-91 comprises a silicon oxide (SiO₂) to aluminum oxide (Al₂O₃) mole ratio (SAR) of 80 to 160; at least 80% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 4. In some embodiments, zeolite SSZ-91 comprises a silicon oxide (SiO₂) to aluminum oxide (Al₂O₃) mole ratio (SAR) of 100 to 140; at least 80% polytype 6 of the total ZSM-48-type material; 0.1 to 4.0 wt. % of an EUO-type molecular sieve phase; wherein the zeolite SSZ-91 has a morphology characterized as polycrystalline aggregates comprising crystallites collectively having an average aspect ratio of between 1 and 4. In some embodiments, zeolite SSZ-91 comprises a silicon oxide (SiO₂) to aluminum oxide (Al₂O₃) mole ratio (SAR) of 100 to 140; at least 80% polytype 6 of the total ZSM-48-type material; 0.1 to 4.0 wt. % of EU-1; wherein the zeolite SSZ-91 has a morphology characterized as polycrystalline aggregates comprising crystallites collectively having an average aspect ratio of between 1 and 4.

Zeolite SSZ-91 synthesized as described herein can be characterized by their XRD pattern. The powder XRD lines of Table 1 are representative of as-synthesized zeolite SSZ-91. Minor variations in the diffraction pattern can result from variations in the mole ratios of the framework species of the sample due to changes in lattice constants. In addition, sufficiently small crystals will affect the shape and intensity of peaks, leading to significant peak broadening. Minor variations in the diffraction pattern can also result from variations in the organic compound used in the preparation and from variations in the Si/Al mole ratio from sample to sample. Calcination can also cause minor shifts in the XRD pattern. Notwithstanding these minor perturbations, the basic crystal lattice structure remains unchanged.

TABLE 1
Characteristic Peaks for As-Synthesized SSZ-91

| 2-Theta^{(a)} | d-spacing (nm) | Relative Intensity^{(b)} |
|---|---|---|
| 7.55 | 1.170 | W |
| 8.71 | 1.015 | W |
| 12.49 | 0.708 | W |
| 15.12 | 0.586 | W |
| 21.18 | 0.419 | VS |
| 22.82 | 0.390 | VS |
| 24.62 | 0.361 | W |
| 26.39 | 0.337 | W |
| 29.03 | 0.307 | W |
| 31.33 | 0.285 | W |

^{(a)}±0.20
^{(b)}The powder XRD patterns provided are based on a relative intensity scale in which the strongest line in the X-ray pattern is assigned a value of 100: W = weak (>0 to ≤20); M = medium (>20 to ≤40); S = strong (>40 to ≤60); VS = very strong (>60 to ≤100).

The X-ray diffraction pattern lines of Table 2 are representative of calcined SSZ-91.

TABLE 2
Characteristic Peaks for Calcined SSZ-91

| 2-Theta^{(a)} | d-spacing (nm) | Relative Intensity^{(b)} |
|---|---|---|
| 7.67 | 1.152 | M |
| 8.81 | 1.003 | W |
| 12.61 | 0.701 | W |
| 15.30 | 0.579 | W |
| 21.25 | 0.418 | VS |
| 23.02 | 0.386 | VS |
| 24.91 | 0.357 | W |
| 26.63 | 0.334 | W |
| 29.20 | 0.306 | W |
| 31.51 | 0.284 | W |

^{(a)}±0.20
^{(b)}The powder XRD patterns provided are based on a relative intensity scale in which the strongest line in the X-ray pattern is assigned a value of 100: W = weak (>0 to ≤20); M = medium (>20 to ≤40); S = strong (>40 to ≤60); VS = very strong (>60 to ≤100).

The powder X-ray diffraction patterns presented herein were collected by standard techniques. The radiation was CuK_{α} radiation. The peak heights and the positions, as a function of 2θ where θ is the Bragg angle, were read from the relative intensities of the peaks (adjusting for background), and d, the interplanar spacing corresponding to the recorded lines, can be calculated.

Zeolite SSZ-91 can be used as-synthesized, but typically will be thermally treated (calcined). The term “as-synthesized” refers to the zeolite SSZ-91 in its form after crystallization, prior to removal of the SDA cation. The SDA can be removed by thermal treatment (e.g., calcination), for example in an oxidative atmosphere (e.g., air, gas with an oxygen partial pressure of greater than 0 kPa) at a temperature readily determinable by one skilled in the art sufficient to remove the SDA from the molecular sieve. The SDA can also be removed by ozonation and photolysis techniques (e.g., exposing the SDA-containing molecular sieve product to light or electromagnetic radiation that has a wavelength shorter than visible light under conditions sufficient to selectively remove the organic compound from the molecular sieve) as described in U.S. Pat. No. 6,960,327.

Zeolite SSZ-91 can be subsequently calcined in steam, air or inert gas at temperatures ranging from 200° C. to 800° C. for periods of time ranging from 1 hour to a number of days, for example 1 to 48 hours. Usually, it is desirable to remove the extra-framework cation (e.g., Na⁺) by ion exchange and replace it with hydrogen, ammonium, or any desired metal-ion.

Where the molecular sieve formed is an intermediate molecular sieve, the target molecular sieve (e.g., zeolite SSZ-91) can be achieved using post-synthesis techniques such as heteroatom lattice substitution techniques. The target molecular sieve (e.g., zeolite SSZ-91) can also be achieved by removing heteroatoms from the lattice by known techniques such as acid leaching.

Zeolite SSZ-91 made from the process disclosed herein can be formed into a wide variety of physical shapes. Zeolite SSZ-91 can be in the form of a powder, a granule, or a molded product, such as extrudate having a particle size sufficient to pass through a 2-mesh (Tyler) screen and be retained on a 400-mesh (Tyler) screen. In cases where the catalyst is molded, such as by extrusion with an organic binder, the zeolite SSZ-91 can be extruded before drying, or, dried or partially dried and then extruded.

Zeolite SSZ-91 can be composited with other materials resistant to the temperatures and other conditions employed in organic conversion processes. Such matrix materials include active and inactive materials and synthetic or naturally occurring molecular sieves as well as inorganic materials such as clays, silica, and metal oxides. Examples of such materials and the manner in which they can be used are disclosed in U.S. Pat. Nos. 4,910,006 and 5,316,753.

The hydroisomerization catalyst, such as zeolite SSZ-91, may be in as-synthesized or calcined form. In some embodiments, the hydroisomerization catalyst is formed from zeolite SSZ-91 in calcined form. In some embodiments, the hydroisomerization catalyst comprises: a molecular sieve selected from zeolite SSZ-91 and a Group 2, 8, 9 or 10 metal (for example a Group 8-10 metal such as Pt).

In some embodiments, the hydroisomerization catalyst is formed by compositing molecular sieve zeolite SSZ-91 (in as-synthesized or calcined form) with an oxide binder such as alumina. In some embodiments, compositing molecular sieve zeolite SSZ-91 (in as-synthesized or calcined form) with an oxide binder comprises mixing a molecular sieve selected from zeolite SSZ-91 (in as-synthesized or calcined form) with an oxide binder and extruding the product. The mixture of the molecular sieve and the oxide binder may be formed into a particle or extrudate having a wide range of physical shapes and dimensions. In some embodiments, the extrudate or particle may be dried and calcined prior to metal loading. In some embodiments, the extrudate or particle is impregnated with a metal, e.g., a Group 2, 8, 9 or 10 metal (for example a Group 8-10 metal such as Pt). and then dried and calcined. In some embodiments, the extrudate or particle is dried and calcined prior to metal loading.

In some embodiments, the hydroisomerization catalyst is prepared by compositing a molecular sieve (such as zeolite SSZ-91) with an oxide binder to form an extrudate base; impregnating the extrudate base with an impregnation solution containing a metal, for example a Group 2, 8, 9 or 10 metal (for example a Group 8-10 metal such as Pt), to form a metal-loaded extrudate; drying the metal-loaded extrudate; and calcining the dried metal-loaded extrudate.

In some embodiments, the hydroisomerization catalyst is formed by impregnating a molecular sieve (such as zeolite SSZ-91) with a solution containing a metal, for example a Group 2, 8, 9 or 10 metal (for example a Group 8-10 metal such as Pt). In some embodiments, the hydroisomerization catalyst is formed by impregnating the molecular sieve in calcined form with a solution containing a Group 2, 8, 9 or 10 metal (for example a Group 8-10 metal such as Pt). In some embodiments, the hydroisomerization catalyst is formed by impregnating an extrudate base comprising the molecular sieve and an oxide binder. In some embodiments, the extrudate base is exposed to an impregnation solution (for example, soaked in an impregnation solution) containing a metal (e.g., a Group 2, 8, 9 or 10 metal (for example a Group 8-10 metal such as Pt)) for 0.1 to 10 hours.

In some embodiments, the extrudate base is dried (for example at a temperature in the range of about 100° F. (38° C.) to about 300° F. (149° C.) for about 0.1 to about 10 hours) and calcined (at a temperature in the range of about 390° F. (199° C.) to about 1200° F. (649° C.), or about 600° F. (316° C.) to about 1200° F. (649° C.) for about 0.1 to about 10 hours) prior to impregnation.

In some embodiments, the extrudate base formed by compositing the molecular sieve (such as from zeolite SSZ-91) and an oxide binder is dried and calcined prior to impregnation. In some embodiments, the dried and calcined extrudate base is impregnated with an impregnation solution to form a metal-loaded extrudate before being dried and calcined again to form the hydroisomerization catalyst.

In some embodiments, the impregnated extrudate base comprising zeolite SSZ-91, is dried at a temperature in the range of about 100° F. (38° C.) to about 300° F. (149° C.) for about 0.1 to about 10 hours. In some embodiments, the dried metal-loaded extrudate is calcined at a temperature in the range of about 600° F. (316° C.) to about 1200° F. (649° C.) for about 0.1 to about 10 hours. In some embodiments, calcination takes place in air.

The process of hydroconverting a biofeedstock comprises contacting a biofeedstock with a hydroconversion catalyst under hydroconversion conditions. Hydroconversion takes place in the presence of hydrogen and may include hydrotreating and hydroisomerization processes.

In some embodiments according to the invention, the hydroconversion takes place in the presence of a hydroconversion catalyst comprising SSZ-91. In some embodiments, the hydroisomerization catalyst comprises SSZ-91. In some embodiments, the biofeedstock contains only renewable biocomponents. The biofeedstock may also be utilized by itself, i.e., wherein no fossil fuel component or other non-biofeedstock component is added along with the biofeedstock.

The process may also be a single stage process, e.g., wherein no intermediate and/or final products are removed between stages or catalyst beds. The process may be advantageously carried out within a single reactor in some embodiments. In some embodiments, the process may be carried out in two or more reactors connected in series, with a first reactor, or catalyst section, comprising a hydrotreating section and a reactor, or catalyst section, downstream from the first reactor or catalyst section comprising a hydroisomerization section. In some embodiments, all of the products from the hydrotreating section are directly passed to the hydroisomerization section, i.e., no intermediate products are removed between the sections. In some embodiments, a separate hydrocracking catalyst is not used within the process to produce a renewable product. The skilled artisan will appreciate that various reactor configurations and catalyst loading arrangements are possible according to the invention.

The hydroconversion conditions typically comprise a temperature in the range of about 300° F. to about 800° F. (149° C. to 427° C.); a pressure in the range of about 15 to about 3000 psig (0.10 to 20.68 MPa gauge); a feed rate of biofeedstock in the range from about 0.1 to about 20 h⁻¹ LHSV; and hydrogen and biofeedstock feed rates in a ratio from about 1000 or 1500, or 2000 to about 10,000 standard cubic feet H₂ per barrel biofeedstock (from about 180 to about 1800 m³ H₂/m³ feed).

In some embodiments, the hydroisomerization conditions (e.g., the hydroisomerization conditions in reactor 14) include a temperature in the range of about 300° F. to about 800° F. (149° C. to 427° C.), for example, about 550° F. to about 700° F. (288° C. to 371° C.). In some embodiments, the hydroisomerization conditions include a pressure in the range of about 15 to about 3000 psig (0.10 to 20.68 MPa gauge), for example about 100 to about 2500 psig (0.69 to 17.24 MPa). In some embodiments, the hydroisomerization conditions include a feed rate of the biofeedstock to the reactor containing the hydroisomerization catalyst at a rate in the range from about 0.1 to about 20 h⁻¹ LHSV, for example from about 0.1 to about 5 h⁻¹ LHSV.

In some embodiments, the hydroisomerization conditions include hydrogen and biofeedstock fed to the reactor in a ratio from about 1000, or 1500, or 2000 to about 10,000 standard cubic feet H₂ per barrel feedstock (from about 180 to about 1800 m³ H₂/m³ feed, for example from about 2500 to about 5000 scf H₂ per barrel feedstock (from about 440 to about 890 m³ H₂/m³ feed).

In some embodiments, hydroisomerization conditions are as follows: temperature in the range of about 300° F. (149° C.), or 325° F. (163° C.), or 350° F. (177° C.), or 375° F. (191° C.), or 390° F. (199° C.) to about 800° F. (427° C.), e.g., about 550° F. to about 750° F. (288° C. to 399° C.), or 570° F. to about 675° F. (299° C. to 357° C.); pressure in the range of about 15 to about 3000 psig (0.10 to 20.68 MPa gauge), e.g., about 100 to about 2500 psig (0.69 to 17.24 MPa); feed rate of feedstock to the reactor containing the hydroisomerization catalyst at a rate in the range from about 0.1 to about 20 h⁻¹ LHSV, for example from about 0.1 to about 5 h⁻¹ LHSV; and hydrogen and feedstock fed to the reactor in a ratio from about 1000, or 1500, or 2000 to about 10,000 standard cubic feet H₂ per barrel feedstock (from about 180 to about 1800 m³ H₂/m³ feed, for example from about 2500 to about 5000 scf H₂ per barrel feedstock (from about 440 to about 890 m³ H₂/m³ feed).

In some embodiments, contacting the biofeedstock and the hydroisomerization catalyst the process provides an aviation (e.g., jet) fuel that is both hydrotreated and hydroisomerized comprising an increased ratio of isoparaffins to normal paraffins compared to the feedstock. In some embodiments, contacting the biofeedstock and the hydroisomerization catalyst provides a jet fuel exhibiting a boiling point range and/or a reduced jet fuel freezing point compared to the jet fuel boiling point range and/or the jet fuel freezing point of the hydrotreated feedstock that has not been hydroisomerized.

In some embodiments, contacting the biofeedstock and the hydroisomerization catalyst provides a diesel fuel exhibiting a lower cloud point and a lower pour point compared to the cloud point and pour point of the hydrotreated biofeedstock, wherein the diesel fuel exhibits a cloud point at least 10° C. lower than the cloud point of the hydrotreated biofeedstock and a pour point at least 10° C. lower than the pour point of the hydrotreated biofeedstock, or a cloud point at least 20° C. lower than the cloud point of the hydrotreated biofeedstock and a pour point at least 20° C. lower than the pour point of the hydrotreated biofeedstock, or a cloud point at least 30° C. lower than the cloud point of the hydrotreated biofeedstock and a pour point at least 30° C. lower than the pour point of the hydrotreated biofeedstock.

In some embodiments, contacting the biofeedstock and the hydroisomerization catalyst the process provides a diesel fuel comprising an increased ratio of isoparaffins to normal paraffins compared to the feedstock. In some embodiments, contacting the biofeedstock and the hydroisomerization catalyst provides a diesel fuel exhibiting a lower cloud point and a lower pour point compared to the cloud point and pour point of the diesel feedstock.

In some embodiments, contacting the biofeedstock and the hydroisomerization catalyst provides a diesel fuel exhibiting a lower cloud point and a lower pour point compared to the cloud point and pour point of the hydrotreated biofeedstock, wherein the diesel fuel exhibits a cloud point at least 10° C. lower than the cloud point of the hydrotreated biofeedstock and a pour point at least 10° C. lower than the pour point of the hydrotreated biofeedstock, or a cloud point at least 20° C. lower than the cloud point of the hydrotreated biofeedstock and a pour point at least 20° C. lower than the pour point of the hydrotreated biofeedstock, or a cloud point at least 30° C. lower than the cloud point of the hydrotreated biofeedstock and a pour point at least 30° C. lower than the pour point of the hydrotreated biofeedstock.

In some cases, both a sustainable jet fuel and a diesel fuel may be produced by simply varying the process temperature using the same feedstock.

The biofeedstock is generally contacted with a hydrotreating catalyst under hydrotreating conditions prior to contacting the feedstock with the hydroisomerization catalyst. In some embodiments, the hydrotreating conditions include a temperature in the range of about 300° F. (149° C.), or 325° F. (163° C.), or 350° F. (177° C.), or 375° F. (191° C.), or 390° F. to about 800° F. (199° C. to 427° C.), e.g., about 500° F. (260° C.) or 550° F. (288° C.) to about 750° F. (399° C.), 590° F. to about 675° F. (310° C. to 357° C.); a pressure in the range of about 15 to about 3000 psig (0.10 to 20.68 MPa gauge), e.g., about 100 to about 2500 psig (0.69 to 17.24 MPa); a feed rate of feedstock to the reactor containing the hydroisomerization catalyst at a rate in the range from about 0.1 to about 20 h⁻¹ LHSV, for example from about 0.1 to about 5 h⁻¹ LHSV; and hydrogen and feedstock fed to the reactor in a ratio from about 1000, or 1500, or 2000 to about 10,000 standard cubic feet H₂ per barrel feedstock (from about 180 to about 1800 m³ H₂/m³ feed), for example from about 2500 to about 5000 scf H₂ per barrel feedstock (from about 440 to about 890 m³ H₂/m³ feed).

Hydrotreating catalysts may generally comprise a refractory inorganic oxide support and a Group 6 metal modifier and/or a Group 8-10 metal modifier. In some embodiments, the hydrotreating catalyst comprises a refractory inorganic oxide support, a Group 6 metal modifier and a Group 8-10 metal modifier. The oxide support may also be referred to herein as a binder. The support of the hydrotreating catalyst may be prepared from or comprise alumina, silica, silica/alumina, titania, magnesia, zirconia, and the like, or combinations thereof. The hydrotreating catalyst support may comprise amorphous materials, crystalline materials, or combinations thereof. Examples of amorphous materials include, but are not limited to, amorphous alumina, amorphous silica, amorphous silica-alumina, and the like.

In some embodiments, the hydrotreating support may comprise amorphous alumina. When using a combination of silica and alumina, the distribution of silica and alumina in the support may be either homogeneous or heterogeneous. In some embodiments, the support may consist of an alumina gel in which is dispersed the silica, silica/alumina, or alumina base material. The support may also contain refractory materials other than alumina or silica, such as for example other inorganic oxides or clay particles, provided that such materials do not adversely affect the hydrogenation activity of the final catalyst or lead to deleterious cracking of the feedstock.

In some embodiments, silica and/or alumina comprise at least about 90 wt. % of the support of the hydrotreating catalyst, and in some embodiments the support may be at least substantially all silica or all alumina.

In some embodiments, the Group 8-10 metal modifier(s) of the hydrotreating catalyst comprises Fe, Co, Ni, Ru, Rh, Pd, Os, Ir, Pt, or combinations thereof. In some embodiments, the Group 8-10 metal modifier of the hydrotreating catalyst comprises a Group 9 metal, a Group 10 metal, or combinations thereof. In some embodiments, the Group 8-10 metal modifier of the hydrotreating catalyst comprises or is Co and/or Ni. In some embodiments, the Group 8-10 metal modifier of the hydrotreating catalyst comprises or is Ni. In some embodiments, the Group 8-10 metal modifier of the hydrotreating catalyst comprises Co and Ni. In some embodiments, the Group 8-10 metal modifier is an oxide, hydroxide or salt. In some embodiments, the Group 8-10 metal modifier is a salt. The amount of the Group 8-10 metal modifier in the hydrotreating catalyst is generally from 0.1 to 20 wt. % or 0.1 to 25 wt. % (for example, from 1.0, or 2.0 to 10 wt. %), based on the bulk dry weight of the catalyst, calculated as the metal oxide. In some embodiments, the Group 6 metal modifier of the hydrotreating catalyst is selected from Cr, Mo, W, and combinations thereof. In some embodiments, the Group 6 metal modifier of the hydrotreating catalyst comprises or is Mo. In some embodiments, the Group 6 metal modifier is an oxide, an oxo acid, or an ammonium salt of an oxo or polyoxoanion. The amount of the Group 6 metal modifier employed in the hydrotreating catalyst is generally from 5 to 50 wt. % (for example, from 10 to 40 wt. %, or from 15 to 30 wt. %), based on the bulk dry weight of the catalyst, calculated as the metal oxide. In some embodiments the hydrotreating catalyst comprises Ni and Mo.

In some embodiments, the Group 8-10 metal modifier and/or the Group 6 metal modifier of the hydrotreating catalyst may be dispersed on the inorganic oxide support. A number of methods are known in the art to deposit Group 8-10 and/or Group 6 metals, or compounds comprising such metals, onto the support; such methods include ion exchange, impregnation, and co-precipitation. In some embodiments, the impregnation of the support with Group 8-10 and Group 6 metal modifiers may be performed at a controlled pH value. The Group 8-10 and Group 6 metal modifiers may be added to the impregnating solution as a metal salt, such as a halide salt, and/or an amine complex, and/or a salt of a mineral acid. Other examples of metal salts that may be used include nitrates, carbonates, and bicarbonates, as well as carboxylic acid salts such as acetates, citrates, and formates.

Optionally, the impregnated support may be allowed to stand with the impregnating solution, e.g., for a period in the range from about 2 to about 24 hours. Following impregnation of the oxide support with the Group 8-10 metal modifier and/or Group 6 metal modifier, the impregnated support can be dried and/or calcined. After the hydrotreating catalyst has been dried and calcined, the prepared catalyst may be reduced with hydrogen or sulfided with a sulfur-containing compound, as is conventional in the art, and placed into service, for example in a hydrotreating reactor positioned upstream of the hydroisomerization reactor.

For the avoidance of doubt, the present disclosure is directed to the subject-matter described in the following numbered paragraphs:

1. A process for making sustainable jet fuel, the process comprising contacting a hydrocarbonaceous feedstock with a hydroconversion catalyst, wherein the feedstock comprises or is a biofeedstock or a biocomponent feed, and the hydroconversion catalyst comprises zeolite SSZ-91.

2. A process for flexibly making sustainable jet fuel and/or renewable diesel from the same hydrocarbonaceous feedstock, the process comprising contacting a hydrocarbonaceous feedstock with a hydroconversion catalyst, wherein the feedstock comprises or is biofeedstock or a biocomponent feed, and the hydroconversion catalyst comprises zeolite SSZ-91.

3. A process for upgrading a hydrocarbonaceous feedstock, the process comprising:
contacting a hydrocarbonaceous feedstock with a hydroconversion catalyst under hydroconversion conditions to provide a diesel fuel that is both hydrotreated and hydroisomerized and having a reduced cloud point and/or a reduced pour point compared to the cloud point and pour point of the hydrotreated hydrocarbonaceous feedstock that has not been hydroisomerized, and/or to provide a jet fuel having an improved jet fuel that is both hydrotreated and hydroisomerized and having a boiling point range and/or a reduced jet fuel freezing point compared to the jet fuel boiling point range and/or the jet fuel freezing point of the hydrotreated hydrocarbonaceous feedstock that has not been hydroisomerized;
wherein the hydrocarbonaceous feedstock comprises or is a biofeedstock or a biocomponent feed, and the hydroconversion catalyst comprises zeolite SSZ-91.

4. A process according to paragraph 3, wherein the product produced comprises diesel fuel that is both hydrotreated and hydroisomerized and having a reduced cloud point and/or a reduced pour point compared to the cloud point and pour point of the hydrotreated hydrocarbonaceous feedstock that has not been hydroisomerized.

5. A process according to paragraph 3, wherein the product produced comprises jet fuel that is both hydrotreated and hydroisomerized and having a boiling point range and/or a reduced jet fuel freezing point compared to the jet fuel boiling point range and/or the jet fuel freezing point of the hydrotreated hydrocarbonaceous feedstock that has not been hydroisomerized.

6. A process according to any of paragraphs 2-5, wherein the same hydrocarbonaceous feedstock is used to produce sustainable jet fuel and/or renewable diesel.

7. A process according to any of paragraphs 2-6, wherein the process temperature is adjusted to produce either the jet fuel or diesel products.

8. A process according to any of paragraphs 2-6, wherein a hydrocracking catalyst is not required or is not used to produce either the jet fuel or the diesel products.

9. A process according to any of paragraphs 1-8, wherein the feedstock is contacted with a hydrotreating catalyst under hydrotreating conditions to provide a hydrotreated feedstock prior to contacting the hydrotreated feedstock with the hydroconversion catalyst.

10. A process according to paragraph 9, wherein the hydrotreating conditions comprise:
a temperature in the range of about 300° F. to about 800° F. (149° C. to 427° C.), or 450° F. to 750° F. (232° C. to 399° C.);
a pressure in the range of about 15 to about 3000 psig (0.10 to 20.68 MPa gauge);
a feed rate of diesel feedstock to the reactor containing the hydrotreating catalyst at a rate in the range from about 0.1 to about 20 h⁻¹ LHSV; and
hydrogen and feedstock fed to the reactor in a ratio from about 1000 to about 10,000 standard cubic feet H₂ per barrel diesel feedstock (from about 180 to about 1800 m³ H₂/m³ feed).

11. A process according to any of paragraph 1-10, wherein the feedstock is contacted with a hydroisomerization catalyst under hydroisomerization conditions to provide a hydroisomerized feedstock.

12. A process according to paragraph 11, wherein the hydroisomerization conditions comprise:
a temperature in the range of about 300° F. to about 800° F. (149° C. to 427° C.), or 450° F. to 750° F. (232° C. to 399° C.);
a pressure in the range of about 15 to about 3000 psig (0.10 to 20.68 MPa gauge);
a feed rate of diesel feedstock to the reactor containing the hydrotreating catalyst at a rate in the range from about 0.1 to about 20 h⁻¹ LHSV; and
hydrogen and feedstock fed to the reactor in a ratio from about 1000 to about 10,000 standard cubic feet H₂ per barrel diesel feedstock (from about 180 to about 1800 m³ H₂/m³ feed).

13. A process according to any of paragraphs 1-12, wherein the hydroconversion catalyst comprises zeolite SSZ 91 and a Group 8-10 metal.

14. A process according to any of paragraphs 1-13, wherein the hydroconversion catalyst comprises zeolite SSZ-91, wherein the zeolite SSZ-91 has, in its calcined form, an X-ray diffraction pattern substantially as shown in the following Table:

| 2-Theta^{(a)} | d-spacing (nm) | Relative Intensity^{(b)} |
|---|---|---|
| 7.67 | 1.152 | M |
| 8.81 | 1.003 | W |
| 12.61 | 0.701 | W |
| 15.30 | 0.579 | W |
| 21.25 | 0.418 | VS |
| 23.02 | 0.386 | VS |
| 24.91 | 0.357 | W |
| 26.63 | 0.334 | W |
| 29.20 | 0.306 | W |
| 31.51 | 0.284 | W |

^{(a)}±0.20
^{(b)}wherein powder XRD patterns provided are based on a relative intensity scale in which the strongest line in the X-ray pattern is assigned a value of 100: W = weak (>0 to ≤20); M = medium (>20 to ≤40); S = strong (>40 to ≤60); VS = very strong (>60 to ≤100).

15. A process according to any of paragraphs 1-14, wherein the hydroconversion catalyst comprises zeolite SSZ 91 having a silicon oxide to aluminum oxide ratio of 40 to 220, or 70 to 160, or 80 to 160, or 80 to 140, or 100 to 160.

16. A process according to any of paragraphs 1-15, wherein the hydroconversion catalyst comprises zeolite SSZ 91 having at least about 80% polytype 6 of the total ZSM-48-type material present in the zeolite SSZ-91, or at least about 90% polytype 6 of the total ZSM-48-type material present in the zeolite SSZ-91.

17. A process according to any of paragraphs 1-16, wherein the hydroconversion catalyst comprises zeolite SSZ-91 and the zeolite SSZ-91 comprises 0.1 to 4.0 wt. % EUO-type molecular sieve phase.

18. A process according to any of paragraphs 1-17, wherein the hydroconversion catalyst comprises zeolite SSZ 91 comprising 0.1 to 4.0 wt. % EU-1.

19. A process according to any of paragraphs 1-18, wherein the hydroconversion catalyst comprises zeolite SSZ 91 having a morphology characterized as polycrystalline aggregates comprising crystallites collectively having an average aspect ratio of 1 to 4.

20. A process according to any of paragraphs 1-19, wherein the hydroconversion catalyst comprises zeolite SSZ 91 having:
a silicon oxide to aluminum oxide ratio of 40 to 220, or 70 to 160;
a morphology characterized as polycrystalline aggregates comprising crystallites collectively having an average aspect ratio in the range of 1 to 4;
at least about 80% polytype 6 of the total ZSM-48-type material present in the zeolite SSZ-91; and, 0.1 to 4.0 wt. % EUO-type molecular sieve phase.

21. A process according to any of paragraphs 1-20, wherein the hydroconversion catalyst comprises from about 5 to about 95 wt. % zeolite SSZ-91, and from about 0.05 to about 25.0 wt. % of a metal modifier.

22. A process according to any of paragraphs 1-21, wherein the feedstock comprises or is a biofeedstock or a biocomponent feed selected from vegetable oils and animal fats which comprise triglycerides and free fatty acids, for example wherein the biocomponent feed is selected from canola oil, corn oil, soy oils, castor oil, camelina oil, palm oil, and a combination thereof.

23. A process according to paragraphs 1-21, wherein the feedstock comprises or is a biofeedstock or a biocomponent feed selected from canola oil, corn oil, soy oils, castor oil, camelina oil, palm oil, rapeseed oil, soybean oil, colza oil, tall oil, sunflower oil, hempseed oil, olive oil, linseed oil, coconut oil, castor oil, peanut oil, palm oil, mustard oil, cottonseed oil, tallow, yellow and brown greases, lard, train oil, fats in milk, fish oil, algal oil, sewage sludge, cuphea oil, camelina oil, jatropha oil, curcas oil, babassu oil, palm kernel oil, crambe oil, and the like.

24. A process according to any of paragraphs 2-23, wherein contacting the feedstock and the hydroconversion catalyst provides a diesel fuel exhibiting a lower cloud point and a lower pour point compared to the cloud point and pour point of the hydrotreated feedstock.

25. A process according to any of paragraphs 2-24, wherein the diesel fuel exhibits a cloud point at least 10° C. lower than the cloud point of the hydrotreated feedstock and a pour point at least 10° C. lower than the pour point of the hydrotreated feedstock, or a cloud point at least 20° C. lower than the cloud point of the feedstock and a pour point at least 20° C. lower than the pour point of the hydrotreated feedstock, or a cloud point at least 30° C. lower than the cloud point of the hydrotreated feedstock and a pour point at least 30° C. lower than the pour point of the hydrotreated feedstock.

26. A process for providing a diesel fuel exhibiting a lower cloud point and a lower pour point compared to the cloud point and pour point of a hydrotreated feedstock from which the diesel fuel is produced, the process comprising contacting a diesel feedstock and a hydroconversion catalyst comprising zeolite SSZ 91 under hydroconversion conditions to provide a diesel fuel exhibiting a lower cloud point and a lower pour point compared to the cloud point and pour point of a hydrotreated feedstock from which the diesel fuel is produced, wherein the feedstock comprises or is a biofeedstock or a biocomponent feed.

27. A process for providing a jet fuel exhibiting a reduced jet fuel freezing point and/or an improved jet fuel boiling point range compared to the jet fuel freezing point and/or the jet fuel boiling point range of a hydrotreated feedstock from which the jet fuel is produced, the process comprising contacting a jet fuel feedstock and a hydroconversion catalyst comprising zeolite SSZ-91 under hydroconversion conditions to provide a jet fuel exhibiting a reduced jet fuel freezing point and/or an improved jet fuel boiling point range compared to the jet fuel freezing point and/or the jet fuel boiling point range of a hydrotreated feedstock from which the jet fuel is produced, wherein the feedstock comprises or is a biofeedstock or a biocomponent feed.

The present disclosure is not to be limited in terms of the particular embodiments described in this application, which are intended as illustrations of various aspects. Many modifications and variations can be made without departing from its spirit and scope, as may be apparent. Functionally equivalent methods and systems within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, in some cases, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

Where permitted, all publications, patents and patent applications cited in this application are incorporated by reference herein in their entirety, to the extent such disclosure is not inconsistent with the present invention.

1. A process for making sustainable jet fuel, the process comprising contacting a hydrocarbonaceous feedstock with a hydroconversion catalyst, wherein the feedstock comprises or is a biofeedstock or a biocomponent feed, and the hydroconversion catalyst comprises zeolite SSZ-91.

2. A process for flexibly making sustainable jet fuel and/or renewable diesel from the same hydrocarbonaceous feedstock, the process comprising contacting a hydrocarbonaceous feedstock with a hydroconversion catalyst, wherein the feedstock comprises or is biofeedstock or a biocomponent feed, and the hydroconversion catalyst comprises zeolite SSZ-91.

3. A process for upgrading a hydrocarbonaceous feedstock, the process comprising: contacting a hydrocarbonaceous feedstock with a hydroconversion catalyst under hydroconversion conditions to provide a diesel fuel that is both hydrotreated and hydroisomerized and having a reduced cloud point and/or a reduced pour point compared to the cloud point and pour point of the hydrotreated hydrocarbonaceous feedstock that has not been hydroisomerized, and/or to provide a jet fuel having an improved jet fuel that is both hydrotreated and hydroisomerized and having a boiling point range and/or a reduced jet fuel freezing point compared to the jet fuel boiling point range and/or the jet fuel freezing point of the hydrotreated hydrocarbonaceous feedstock that has not been hydroisomerized;
wherein the hydrocarbonaceous feedstock comprises or is a biofeedstock or a biocomponent feed, and the hydroconversion catalyst comprises zeolite SSZ-91.

4. A process according to claim 3, wherein the product produced comprises diesel fuel that is both hydrotreated and hydroisomerized and having a reduced cloud point and/or a reduced pour point compared to the cloud point and pour point of the hydrotreated hydrocarbonaceous feedstock that has not been hydroisomerized.

5. A process according to claim 3, wherein the product produced comprises jet fuel that is both hydrotreated and hydroisomerized and having a boiling point range and/or a reduced jet fuel freezing point compared to the jet fuel boiling point range and/or the jet fuel freezing point of the hydrotreated hydrocarbonaceous feedstock that has not been hydroisomerized.

6. A process according to claim 2, wherein the same hydrocarbonaceous feedstock is used to produce sustainable jet fuel and/or renewable diesel.

7. A process according to claim 2, wherein the process temperature is adjusted to produce either the jet fuel or diesel products.

8. A process according to claim 2, wherein a hydrocracking catalyst is not required or is not used to produce either the jet fuel or the diesel products.

9. A process according to claim 1, wherein the feedstock is contacted with a hydrotreating catalyst under hydrotreating conditions to provide a hydrotreated feedstock prior to contacting the hydrotreated feedstock with the hydroconversion catalyst.

10. A process according to claim 9, wherein the hydrotreating conditions comprise:
a temperature in the range of about 300° F. to about 800° F. (149° C. to 427° C.), or 450° F. to 750° F. (232° C. to 399° C.);
a pressure in the range of about 15 to about 3000 psig (0.10 to 20.68 MPa gauge);
a feed rate of diesel feedstock to the reactor containing the hydrotreating catalyst at a rate in the range from about 0.1 to about 20 h⁻¹ LHSV; and
hydrogen and feedstock fed to the reactor in a ratio from about 1000 to about 10,000 standard cubic feet H₂ per barrel diesel feedstock (from about 180 to about 1800 m³ H₂/m³ feed).

11. A process according to claim 1, wherein the feedstock is contacted with a hydroisomerization catalyst under hydroisomerization conditions to provide a hydroisomerized feedstock.

12. A process according to claim 11, wherein the hydroisomerization conditions comprise:
a temperature in the range of about 300° F. to about 800° F. (149° C. to 427° C.), or 450° F. to 750° F. (232° C. to 399° C.);
a pressure in the range of about 15 to about 3000 psig (0.10 to 20.68 MPa gauge);
a feed rate of diesel feedstock to the reactor containing the hydrotreating catalyst at a rate in the range from about 0.1 to about 20 h⁻¹ LHSV; and
hydrogen and feedstock fed to the reactor in a ratio from about 1000 to about 10,000 standard cubic feet H₂ per barrel diesel feedstock (from about 180 to about 1800 m³ H₂/m³ feed).

13. A process according to claim 1, wherein the hydroconversion catalyst comprises zeolite SSZ 91 and a Group 8-10 metal.

14. A process according to claim 1, wherein the hydroconversion catalyst comprises zeolite SSZ-91, wherein the zeolite SSZ-91 has, in its calcined form, an X-ray diffraction pattern substantially as shown in the following Table:

| 2-Theta^{(a)} | d-spacing (nm) | Relative Intensity^{(b)} |
|---|---|---|
| 7.67 | 1.152 | M |
| 8.81 | 1.003 | W |
| 12.61 | 0.701 | W |
| 15.30 | 0.579 | W |
| 21.25 | 0.418 | VS |
| 23.02 | 0.386 | VS |
| 24.91 | 0.357 | W |
| 26.63 | 0.334 | W |
| 29.20 | 0.306 | W |
| 31.51 | 0.284 | W |

^{(a)}±0.20
^{(b)}wherein powder XRD patterns provided are based on a relative intensity scale in which the strongest line in the X-ray pattern is assigned a value of 100: W = weak (>0 to ≤20); M = medium (>20 to ≤40); S = strong (>40 to ≤60); VS = very strong (>60 to ≤100).

15. A process according to claim 1, wherein the hydroconversion catalyst comprises zeolite SSZ 91 having a silicon oxide to aluminum oxide ratio of 40 to 220, or 70 to 160, or 80 to 160, or 80 to 140, or 100 to 160.

16. A process according to claim 1, wherein the hydroconversion catalyst comprises zeolite SSZ 91 having at least about 80% polytype 6 of the total ZSM-48-type material present in the zeolite SSZ-91, or at least about 90% polytype 6 of the total ZSM-48-type material present in the zeolite SSZ-91.

17. A process according to claim 1, wherein the hydroconversion catalyst comprises zeolite SSZ-91 and the zeolite SSZ-91 comprises 0.1 to 4.0 wt. % EUO-type molecular sieve phase.

18. A process according to claim 1, wherein the hydroconversion catalyst comprises zeolite SSZ 91 comprising 0.1 to 4.0 wt. % EU-1.

19. A process according to claim 1, wherein the hydroconversion catalyst comprises zeolite SSZ 91 having a morphology characterized as polycrystalline aggregates comprising crystallites collectively having an average aspect ratio of 1 to 4.

20. A process according to claim 1, wherein the hydroconversion catalyst comprises zeolite SSZ 91 having:
a silicon oxide to aluminum oxide ratio of 40 to 220, or 70 to 160;
a morphology characterized as polycrystalline aggregates comprising crystallites collectively having an average aspect ratio in the range of 1 to 4;
at least about 80% polytype 6 of the total ZSM-48-type material present in the zeolite SSZ-91; and, 0.1 to 4.0 wt. % EUO-type molecular sieve phase.

21. A process according to claim 1, wherein the hydroconversion catalyst comprises from about 5 to about 95 wt. % zeolite SSZ-91, and from about 0.05 to about 25.0 wt. % of a metal modifier.

22. A process according to claim 1, wherein the feedstock comprises or is a biofeedstock or a biocomponent feed selected from vegetable oils and animal fats which comprise triglycerides and free fatty acids, for example wherein the biocomponent feed is selected from canola oil, corn oil, soy oils, castor oil, camelina oil, palm oil, and a combination thereof.

23. A process according to claim 1, wherein the feedstock comprises or is a biofeedstock or a biocomponent feed selected from canola oil, corn oil, soy oils, castor oil, camelina oil, palm oil, rapeseed oil, soybean oil, colza oil, tall oil, sunflower oil, hempseed oil, olive oil, linseed oil, coconut oil, castor oil, peanut oil, palm oil, mustard oil, cottonseed oil, tallow, yellow and brown greases, lard, train oil, fats in milk, fish oil, algal oil, sewage sludge, cuphea oil, camelina oil, jatropha oil, curcas oil, babassu oil, palm kernel oil, crambe oil, and the like.

24. A process according to claim 2, wherein contacting the feedstock and the hydroconversion catalyst provides a diesel fuel exhibiting a lower cloud point and a lower pour point compared to the cloud point and pour point of the hydrotreated feedstock.

25. A process according to claim 2, wherein the diesel fuel exhibits a cloud point at least 10° C. lower than the cloud point of the hydrotreated feedstock and a pour point at least 10° C. lower than the pour point of the hydrotreated feedstock, or a cloud point at least 20° C. lower than the cloud point of the feedstock and a pour point at least 20° C. lower than the pour point of the hydrotreated feedstock, or a cloud point at least 30° C. lower than the cloud point of the hydrotreated feedstock and a pour point at least 30° C. lower than the pour point of the hydrotreated feedstock.

26-27. (canceled)
